(19) United States
(12) Patent Application Publication
(10) Pub. No.: US 2025/0296493 A1
(43) Pub. Date: Sep. 25, 2025

(54) DUMP TRUCK

(71) Applicant: Logan Corporation, Huntington, WV (US)

(72) Inventor: Randall Keith Risner, Salyersville, KY (US)

(21) Appl. No.: 19/084,064

(22) Filed: Mar. 19, 2025

Related U.S. Application Data
(60) Provisional application No. 63/567,672, filed on Mar. 20, 2024.

(51) Int. Cl. B60P 1/04; B60K 17/28; B60P 1/16

(52) U.S. Cl. CPC B60P 1/045; B60K 17/28; B60P 1/16

(57) ABSTRACT

Present embodiments relate to a dump truck. More specifically, but without limitation, present embodiments relate to a dump truck having a controller which receives inputs of vehicle conditions and controls output related to power take off (PTO) engagement of hydraulic pump and operation of the dump body. The features that provide the inputs improve safe operation of a dump body of the dump truck.

### INCORPORATION BY REFERENCE

Any and all applications for which a foreign or domestic priority claim is identified in the Application Data Sheet as filed with the present application are hereby incorporated by reference herein and made a part of the present disclosure.

### BACKGROUND

### 1. Field of the Invention

Present embodiments relate to a dump truck. More specifically, but without limitation, present embodiments relate to a dump truck having a controller which receives inputs and controls output related to power take off (PTO) operation of a dump body of the dump body.

### 2. Description of the Related Art

Dump trucks provide a utility wherein various materials may be loaded into a dump body of the truck. For example, but without limitation, dump trucks may provide hauling solutions for industries such as mining, aggregate, and construction. The dump truck may be driven to a location where the material is to be unloaded, then the truck bed is raised to unload, or “dump”, the material from the bed.

Various problems may arise in the use of dump trucks. Trucks are sometimes driven with the dump body in the raised position, unknowingly by the driver, after unloading. This can result in striking an overpass or power wires.

Further, the dump body may be engaged for movement in such a manner that can cause undue wear and/or damage to the components driving the hydraulic system which moves the dump body.

It would be desirable to provide a control system which precludes or reduces the chance of damage to a hydraulic system of a dump truck and which promotes safe use.

The information included in this Background section of the specification, including any references cited herein and any description or discussion thereof, is included for technical reference purposes only and is not to be regarded subject matter by which the scope of the claims is to be bound.

### SUMMARY

The present application discloses one or more of the features recited in the appended claims and/or the following features which alone or in any combination, may comprise patentable subject matter.

Present embodiments relate to a dump truck having a controller in communication with a plurality of sensors and which controls the dump body operation. The controller may preclude engagement of the power take off (PTO) with the transmission if certain threshold operating conditions are not met or are out of allowable operating parameters. The controller may also signal safety devices such as a strobe or flashing light to indicate that the PTO is engaged, and dump body may be in operation.

According to some embodiments, a dump truck may comprise a truck main body having a frame, a plurality of wheel assemblies, an engine and a transmission which operably drive at least some of the pluralities of wheel assemblies. A dump body having a base, a plurality of walls extending from the base, and defining a cavity wherein contents may be positioned in the dump body, at least one movable gate which moves between a closed position and an opened position to discard the contents from the cavity. A hydraulic system which is driven by a power take off (PTO) operably connected to the transmission and which powers movement of the dump body from a first position in which the contents may be stored, to a second upstanding position in which the contents may be discarded. A controller for the hydraulic system having a plurality of features. These features may comprise an RPM monitor for the engine, which allows operation of the PTO and the hydraulic system only if the engine is in within a preselected RPM range; a lateral angle inclinometer which determines if the truck main body is within a preselected range of lateral incline to allow operation of the PTO and the hydraulic system; a speed monitor which determines if the dump truck is below a preselected speed for safe operation of the PTO for operation of the dump body; and, a strobe light in electrical communication with the controller, the strobe light being operated by the controller when the PTO is engaged.

In some embodiments, the controller further comprising an override option which allows a user to bypass one or more of the features of the controller.

In some embodiments, the controller may further comprise a text box for messaging a user.

In some embodiments, the RPM monitor precludes engagement of the PTO if an engine RPM is outside of the preselected RPM range.

In some embodiments, the preselected RPM range being between about 350 RPM and 3000 RPM.

In some embodiments, the dump truck may further comprise a second inclinometer for measuring front to rear tilt of the dump truck.

In some embodiments, the lateral angle inclinometer having the preselected angle range of between about 0 and 16 degrees.

In some embodiments, the dump truck may further comprise a user defined input for the speed monitor.

In some embodiments, the preselected speed is between about 0 mph and about 16 mph.

According to some embodiments, a method of operating a dump body, comprises the steps of: receiving an input at a controller to operate the dump body; determining, by a first input and with the controller whether an engine RPM is within a first acceptable range; determining, by a second input and with the controller whether a vehicle speed is within a second acceptable range; determining, by a third input and with the controller whether an angle of the vehicle is within a third acceptable range.

In some embodiments, the method may comprise an override option to allow a user to bypass one or more of the first acceptable range, the second acceptable range, or the third acceptable range.

In some embodiments, the method may further comprise providing a power take off (PTO) output by the controller to engage the PTO.

In some embodiments, the method may further comprise providing a strobe light output signal by the controller to operate a strobe light.

In some embodiments, the method may further comprise moving the dump body if said first acceptable range, said second acceptable range, and said third acceptable range are met.

In some embodiments, the angle is front-to-rear angle, lateral angle, or both.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. All of the above outlined features are to be understood as exemplary only and many more features and objectives of the various embodiments may be gleaned from the disclosure herein. Therefore, no limiting interpretation of this summary is to be understood without further reading of the entire specification, claims and drawings, included herewith. A more extensive presentation of features, details, utilities, and advantages of the present embodiments is provided in the following written description of various embodiments, illustrated in the accompanying drawings, and defined in the appended claims.

### BRIEF DESCRIPTION OF THE DRAWINGS

In order that the embodiments may be better understood, embodiments of a dump truck will now be described by way of examples. These embodiments are not to limit the scope of the claims as other embodiments of a dump truck will become apparent to one having ordinary skill in the art upon reading the instant description. Non-limiting examples of the present embodiments are shown in figures wherein:

FIG. 1 is a rear perspective view of a dump truck having a dump body in a down position, according to some embodiments;

FIG. 2 is a side view of the dump truck of FIG. 1, with the dump body in an up position, according to some embodiments;

FIG. 3 is a schematic side view of a transmission with a power take off (PTO) mounted hydraulic components, according to some embodiments;

FIG. 4 is a schematic view of a hydraulic system for a dump body, according to some embodiments;

FIG. 5 is a schematic perspective view of a hydraulic system for a dump body, according to some embodiments;

FIG. 6 is a schematic layout of a controller which operates the hydraulic system for the dump body; and,

FIG. 7 is a flow chart of a method of operation of the dump body operation.

### DETAILED DESCRIPTION

It is to be understood that a dump truck is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present description. Thus, appearances of the phrases “in one embodiment”, “in some embodiments” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

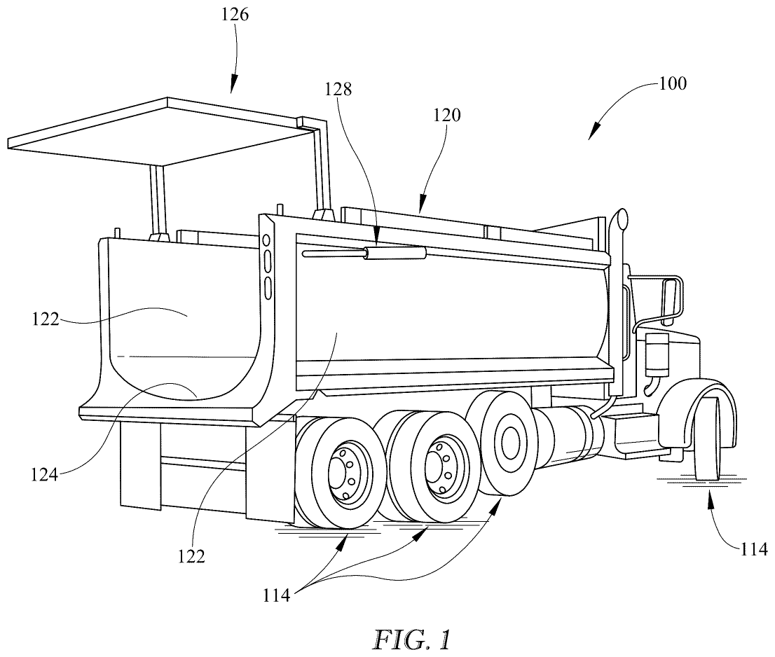

Referring now to FIGS. 1-7, a dump truck 100 is provided with a dump body 120 that is movable between an up position and a down position. The dump body 120 is operated by a power take off (PTO) which engages or disengages from a transmission, in order to drive a hydraulic system. The hydraulic system moves the dump body between the up and the down positions. The hydraulic system also has a controller which receives inputs and controls output related to power take off (PTO) operation of the dump body. The controller may preclude engagement of the power take off (PTO) with the transmission if certain threshold operating conditions are not met or are out of allowable operating parameters. The controller also engage safety devices based on switch conditions related to operation of the dump body, controller, and/or PTO.

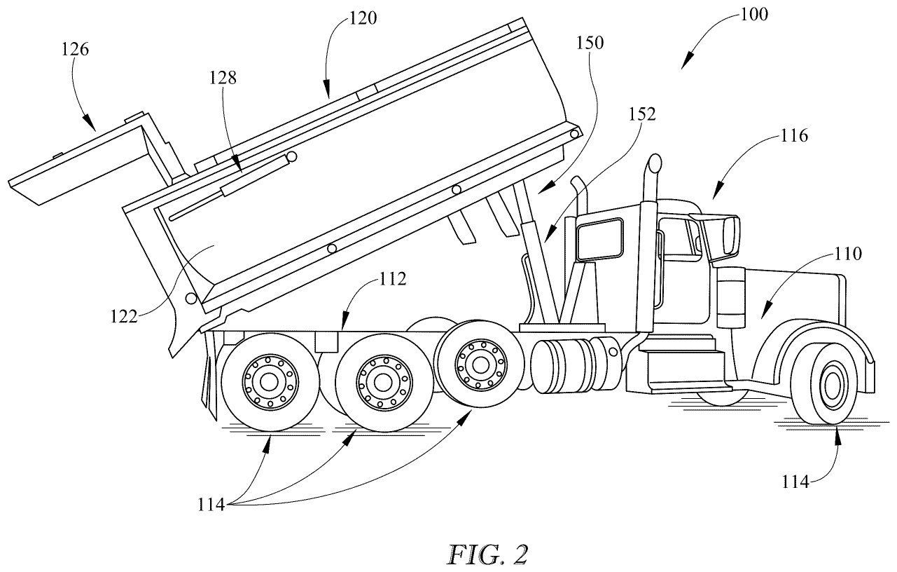

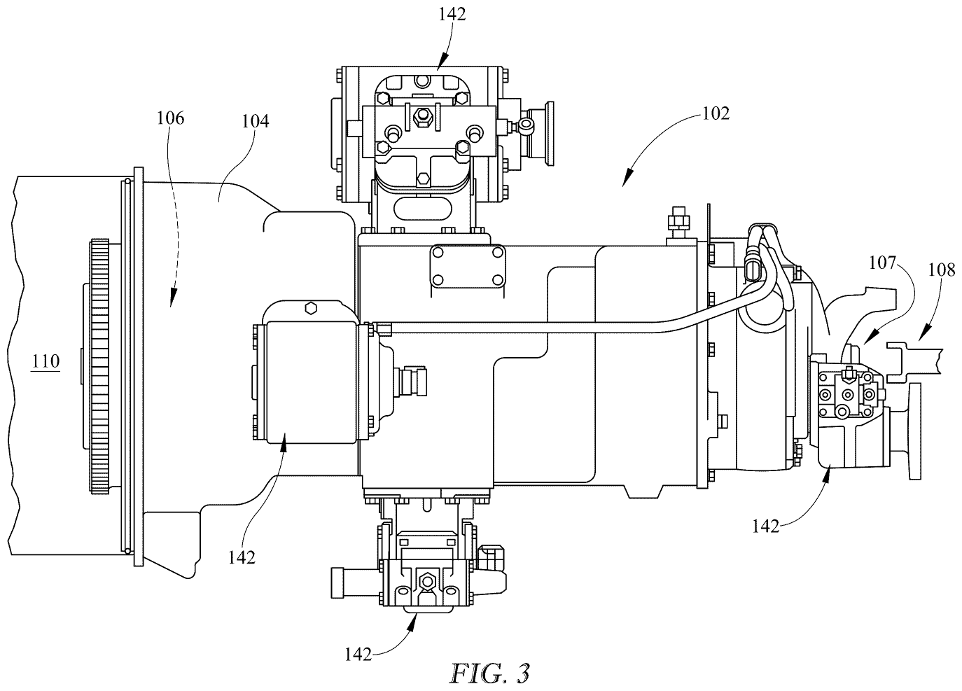

Referring now to FIG. 1, a rear perspective view of a dump truck 100 is shown according to one or more embodiments. The dump truck 100 has a dump body 120, also commonly referred to as a dump bed, in a down or lowered position. The dump truck 100 comprises a frame 112 (FIG. 2) and a plurality of wheel assemblies 114. The dump truck 100 employs a prime mover 110 (FIG. 3), for example a combustion engine such as a gasoline engine or diesel engine, to power the dump truck 100 and provides propulsion for both traveling and movement of the dump body 120, according to the instant embodiment. In some embodiments, the engine 110 may be embodied by an electric motor. The engine 110 is generally located beneath a hood and on the frame 112 as will be understood by one skilled in the art.

The dump truck 100 may comprise a suspension which connects the plurality of wheel assemblies 114 and the frame 112. Some or all of the wheel assemblies 114 may be driven by the engine 110 by way of transmission 102 and drive train which transmit power and torque to one or more of the wheel assemblies 114 to propel the dump truck 100. The dump truck 100 may comprise a passenger compartment or cab 116 (FIG. 2) atop the frame 112 wherein a driver or user may control both operation of the truck and the operation of the dump body 120. The dump body 120 is located behind the cab 116 and is shown in the down position wherein materials may be loaded or transported therein. Additionally, while the dump body 120 is shown on the tractor (powered portion) of the dump truck 100, the dump body 120 may also be provided on a trailer which is pulled behind the tractor.

The dump body 120 may comprise a plurality of sidewalls 122 which extend from a floor 124 of the dump body 120. In the depicted embodiment, the dump body 120 may comprise three (3) sidewalls 122 that extend from the floor 124. At a rear end of the dump body 120, a gate 126 is provided through which material in the dump body 120 may be dumped out.

In the depicted embodiment, the gate 126—may be hydraulically or pneumatically powered to open and close. For example, the gate 126 may be connected to a gate hydraulic or pneumatic component 128 to open and close the gate 126. The gate 126 is shown in an open position which is desirable when the dump body 120 is to be raised to unload material. Once unloaded, the gate 126 may be lowered to fully enclose the dump body 120. While the gate 126 may be powered in some embodiments, the gate 126 may also be free to swing so that it opens by gravity as the dump body 120 is raised.

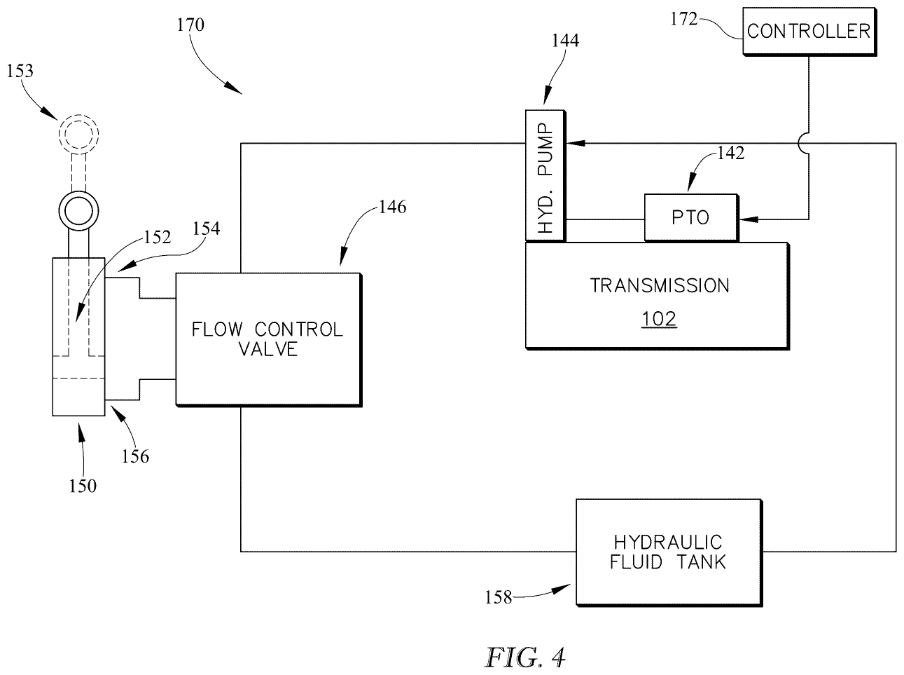

The engine 110 also provides power for a hydraulic system 140 (FIG. 4) and electrical systems 170 (FIG. 4) on the dump truck 100, as well as providing a power supply for various vehicle accessories. For example, the hydraulic system 140 may power movement of the dump body 120 and the gate 126. Among other things, the electrical system 170 may comprise a controller 172 that governs operation of the hydraulic system 140 from a power take off (PTO) 142 which may be connected to the transmission 102.

Referring now to FIG. 2, a side view of the dump truck 100 is shown. The gate 126 is shown in the open position and the dump body 120 is in the up or raised position. The dump body 120 is moved by the hydraulic system 140, comprising a hydraulic cylinder 150 and piston 152. The hydraulic system 140 may be powered by the engine 110, indirectly, and more specifically by a power take off (PTO) 142 (FIG. 4) which either engages or disengages from the dump truck transmission 102.

The piston 152 is shown in an extended position relative to the cylinder 150 which raises the dump body 120. When the piston 152 is retracted, the dump body 120 is lowered to the position shown in FIG. 1.

Referring now to FIG. 3, a side schematic view of the transmission 102 is shown. The transmission 102 includes a casing 104 and at the left side of the transmission 102 includes a torque converter 106 that engages with and transmits power from the engine 110 to a transmission input shaft (not shown) and multiplies engine torque output. Alternatively, in dump trucks with a manual transmission, the transmission 102 may be engaged and disengaged by a clutch in order to transmit power from the engine 110 to the transmission 102.

The transmission 102 may further comprise a plurality of gears within the casing 104 that receive input at one speed and change the output to a second speed, in order to drive a drive shaft 108 (shown schematically and exploded). The right side of the transmission 102 may include an output 107 which drives the drive shaft 108. The transmission 102 may be a multi-gear system, for example, a ten-speed transmission having high torque characteristics including the one or more power takeoff connections. In some embodiments, an exemplary transmission may be an Allison 4500 transmission. In other embodiments, an exemplary transmission may be a Mack MAXITORQUE ES series, for example model T310. The examples are non-limiting and without limitation.

The transmission 102 may include one or more locations with power take offs (PTOs) 142 (FIG. 4) which allow for powering of one or more accessory components. The transmission 102 is shown having a plurality of locations for mounting of a PTO 142. For example, in the side view, PTOs 142 may be located at one of more mounting locations such as top, bottom, sides, or an end of the transmission 102. In the instant embodiments, the accessory components may comprise a hydraulic motor and/or a hydraulic pump 144 (FIG. 4). The one or more PTOs 142 may operate continuously whether or not the transmission 102 is driveably engaged with the engine 110. In other words, the one or more PTOs 142 may operate whether or not the drive shaft 108 is being driven by the transmission 102. In the event there are two or more PTOs, one PTO 142 may function when the drive shaft 108 is being driven by the transmission 102 and one may function when the drive shaft 108 is not being driven by the transmission 102. A controller 172 (FIG. 4) may be provided to make determinations about the engagement and disengagement between the PTO 142 and the transmission 102, as will be described further herein.

Referring now to FIG. 4, a schematic view of the engagement between the transmission 102 and hydraulic pump 144, is depicted in addition to the remainder of an exemplary hydraulic system 140 used for raising and lowering the dump body 120 (FIGS. 1, 2). In the schematic view depicted, the transmission 102 is shown and receives power input from the engine 110 (FIG. 3), as will be understood by one skilled in the art. The transmission 102 comprises the PTO 142 which drives the hydraulic pump 144.

This pump 144 is in fluid communication with a hydraulic fluid tank 158 which holds a pre-determined amount of hydraulic fluid and a flow control valve 146. The hydraulic pump 144 receives hydraulic fluid from the hydraulic fluid tank 158 and forces the hydraulic fluid to the flow control valve 146. The flow control valve 146 may change positions selectively to send fluid to the cylinder 150 in either of two locations or connectors 154, 156. At one location 156, the fluid pressure on the head of the piston 152 causes the piston 152 to extend. At the second location 154, the hydraulic fluid is on the upper side of the piston 152 so that the piston 152 retracts.

Hydraulic fluid moves from the flow control valve 146 to the hydraulic fluid tank 158. The hydraulic fluid tank 158 provides a reservoir of fluid which subsequently returns to the hydraulic pump 144.

Additionally, a controller 172 is shown. The controller 172 is shown with a schematic connection to the PTO 142 and controls engagement of the PTO 142 with the transmission 102, as will be described further herein.

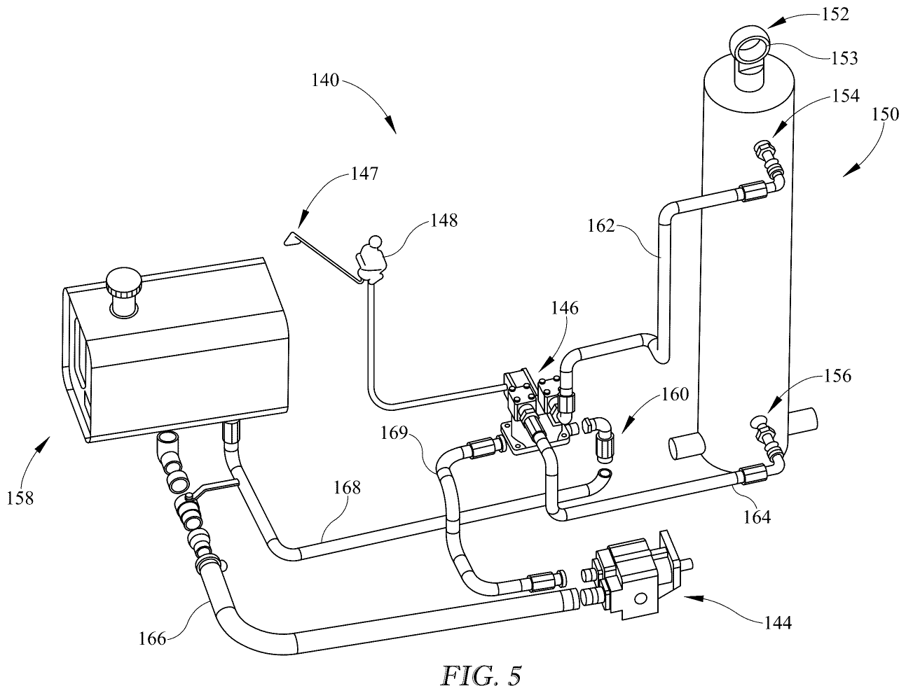

Referring now to FIG. 5, a basic hydraulic system 140 is shown in schematic view for purpose of. A hydraulic fluid tank 158 is shown with an input and an output. The hydraulic fluid tank 158 may store hydraulic fluid for the hydraulic system 140 that moves through the various conduits depicted. The hydraulic system 140 is shown with a switch 147, which may direct the engagement of the PTO 142 (FIG. 4) and a joystick or lever 148 to raise, lower, and/or jog the dump body 120. The switch 147 may cause engagement of the PTO to drive the pump 144 and thus create hydraulic pressure. In some embodiments, the joystick or lever 148 may be a three-position device. In some other embodiments, the joystick or lever may be embodied by a second switch with multiple positions to direct the dump body up, down, or to hold. One or both of the switch 147 and the lever 148 are operably connected to a flow control valve 146 which direct flow of hydraulic fluid based on the direction of the joystick or lever 148.

Adjacent to the flow control valve 146 is the cylinder 150 and piston 152. The cylinder 150 is provided to house a piston 152 which may be extended (FIG. 2) or may be retracted as shown in (FIGS. 1, 5). The piston 152 is represented by a joint 153 extending from an upper end of the cylinder 150. For example, in some embodiments, the joint 153 may be a knuckle joint but this is not to be considered limiting. The joint 153 may move upward from the depicted position to a second, extended position, shown in FIG. 2. The cylinder 150 may comprise first and second fluid connectors 154, 156 for connection with hydraulic fluid conduits 162, 164, respectively. The first and second fluid connectors 154, 156 allow for in flow and out flow of hydraulic fluid in order that the piston 152 may be extended or retracted. In generally, when the hydraulic fluid is directed to the upper end of the cylinder 150 at connector 154, the piston 152 will retract and fluid moves out of the cylinder 150 at the lower connector 156. When the hydraulic fluid is directed to the lower fluid connector 156, the piston 152 extends and fluid moves out of the cylinder 150 through the upper fluid connector 154.

Adjacent to the flow control valve 146 and cylinder 150 is the hydraulic pump 144. The pump 144 may be powered by the PTO 142 (FIG. 4) or by a motor which is connected to the PTO 142. The pump 144 pressurizes the hydraulic fluid system 140 so that the fluid may be directed by the flow control valve 146 may direct fluid movement to and from the cylinder 150.

The hydraulic system 140 comprises a plurality of fluid conduits 160 which interconnect the various components. For example, input conduit 166 and output conduits 168 extend from the hydraulic fluid tank 158. One conduit 166 supplies hydraulic fluid to the hydraulic pump 144 and the other conduit 168 extends from the flow control valve 146 and returns hydraulic fluid to the hydraulic fluid tank 158. The conduits 162, 164 also extend from the flow control valve 146 to the cylinder 150 in order to extend or retract the piston 152. Another conduit 169 extends from the pump 144 to the flow control valve 146. In operation, the pump 144 supplies pressurized fluid to the flow control valve 146. The flow control valve 146 then directs hydraulic fluid to one or the other of the fluid connectors 154, 156 of the cylinder 150. Fluid returning from the cylinder 150 moves through the flow control valve 146 and returns to the hydraulic fluid tank 158. The direction of the fluid is controlled by the joystick or lever 148

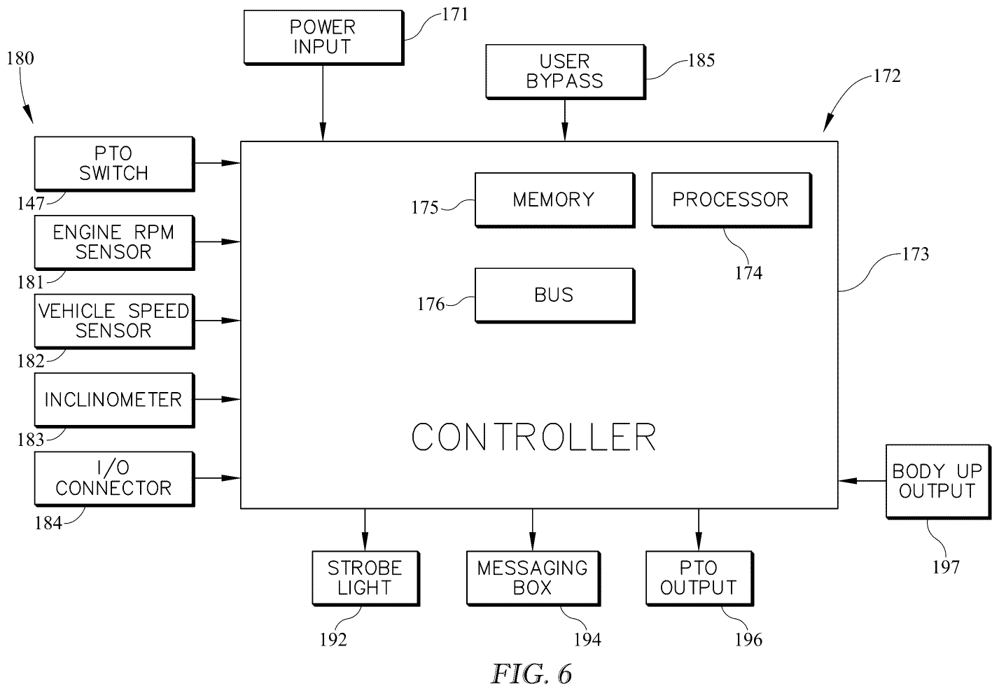

Referring now to FIG. 6, a schematic view of a controller 172 is depicted. The controller 172 functions to make determinations about whether the operating conditions are appropriate for operation of the dump body 120. Accordingly, the controller 172 may allow engagement of the PTO 142 (FIG. 4) and the transmission 102. Once the PTO 142 is engaged, the hydraulic system 140 may be operated.

The controller 172 may be mounted in various locations of the dump truck 100 including externally or in the cab 116. The controller 172 (computing device) may be a solid state device defining an electronic control unit (ECU), a central processing unit (CPU), and/or the like and may be defined by one or more controllers. The controller 172 may comprise a printed circuit board (PCB) 173, at least one processor 174, at least one memory 175, and/or other component(s) of computing device(s). In some embodiments, the controller 172 may comprise one or more circuit boards 173, which may be individually connected to individual furnace components, or which may be connected to two or more of the furnace components. The controller 172 may comprise a primary board and a daughter board for control of certain features. Each circuit board 173 may comprise one or more modules for control. The controller 172 may be configured to control engagement of the PTO 142 with the transmission 102 if the controller 172 determines that operating conditions are acceptable.

The PCB 173 may for example comprise an electronic processor 174 (for example, a microprocessor, a microcontroller, or another suitable programmable device or combination of programmable devices), a memory 175, and a bus 176, such as a controller-area network bus (“CAN bus”), for example a DANFOSS Gateway CG150. In some embodiments, the circuit board 173 may comprise a second circuit board. For example, the first board may control some functions, and the second board may control other functions.

The bus 176 connects various components of the PCB 173, such as the memory 175 to the electronic processor 174. The memory 175 includes, for example, a read-only memory (“ROM”), a random access memory (“RAM”), an electrically erasable programmable read-only memory (“EEPROM”), a flash memory, a hard disk, or another suitable magnetic, optical, physical, or electronic memory device. The electronic processor 174 may be connected to the memory 175 and executes software instructions that are capable of being stored in the RAM (for example, during execution), the ROM (for example, on a permanent basis), or another non-transitory computer readable medium such as another memory or disc. Additionally, or alternatively, the memory 175 is included in the electronic processor 174. In some embodiments the memory 175 may comprise one or more non-transitory computer readable storage media storing computer instructions executable by one or more processors 174 to perform any of the aforementioned methods. Some embodiments also include a computer program product including instructions executable by one or more processors 174 to perform any of the aforementioned methods. Software included in the implementation of the hydraulic system 140 may be stored in the memory 175 of the respective controller 172 that it pertains to. The software includes, for example, firmware, one or more applications, program data, one or more program modules, and other executable instructions. The controllers 172 are configured to retrieve from the memory 175 and execute, among other things, instructions related to the control processes and methods described herein. In some embodiments, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Python, Java, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

In some embodiments, controller 172 includes one or more memory devices 175 and one or more processors 174. The processors 174 can be any combination of general or special purpose processors, CPUs, or the like that can execute programming instructions or control code associated with operation of hydraulic system 140. The memory devices 175 (i.e., memory) may represent random access memory such as DRAM or read only memory such as ROM or FLASH. In one embodiment, the processor 174 executes programming instructions stored in memory 175. The memory 175 may be a separate component from the processor 174 or may be included onboard within the processor 174. The one or more memory devices 175 may be store data, for example lookup table(s) relating to any or all of the inputs 180 including preselected values and/or ranges for acceptable operation. Alternatively, controller 172 may be constructed without using a processor, for example, using a combination of discrete analog or digital logic circuitry (such as switches, amplifiers, integrators, comparators, flip-flops, AND gates, and the like) to perform control functionality instead of relying upon software.

The PCB 173 of each controller 172 may also comprise, among other things, a plurality of additional passive and active components such as resistors, capacitors, inductors, integrated circuits, converters, and amplifiers. These components are arranged and connected to provide a plurality of electrical functions to the PCB 173 including, among other things, filtering, signal conditioning, signal converter, and voltage regulation.

Each controller 172 may also include an input/output (“I/O”) system that includes routines for transferring information between components within the controller 172 and/or other components of the dump truck 100. This may be incorporated in the vehicle bus 176 or may incorporated in other manners. The I/O system may include a wireless receiver/transmitter for wireless communicating with other controllers and/or an external device. In some embodiments, each controller 172 receives power input 171 from a power supply (for example, an input power). The input power may comprise various forms, for example, a main power supply, an alternator, a battery source, for example, 12V, 24, V, 48V, etc., solar panels, thermo-electric generators (TEG), or other power adapter.

The controller 172 may be an integrated controller or a distributed controller that directs operation of hydraulic system 140 of dump truck 100. The controller 172 includes an interface to receive, for example, input 180 to make determinations about operating mode status for the dump truck 100. The environmental conditions may include indoor temperature and relative humidity of the passenger compartment 116. In a typical embodiment, the controller 172 also includes a processor 174 and a memory 175 to direct operation of the hydraulic system 140 based on conditions of the dump truck 100.

The controller 172 receives a plurality of inputs 180 from various sensors to consider characteristics and conditions and make a determination about and whether the dump body 120 may be raised or lowered.

The controller 172 is shown with the plurality of inputs 180 disposed along one side thereof, for ease of explanation. The controller 172 may comprise an input from the switch 147 which inputs to the controller 172. The switch 147 may be located in the cab 116 (FIG. 2) of the dump truck 100 and actuated by the driver or user when it is desired to use of the hydraulic system 140. More specifically however, the actuation of the switch 147 engages the PTO 142 to operate the dump body 120. Upon actuation of the switch 147, the controller 172 may begin a determination process to determine whether the engagement of the PTO 142 is appropriate. This may be a first action when it is desired to raise the dump body 120.

Additionally, the controller 172 may receive an input of the engine speed or RPM from an engine RPM sensor 181. Operation of a hydraulic pump 144 should occur within a specific RPM range that may be dependent on pump requirements. Operation of the pump 144 outside this range may result in damage to the pump 144 and the hydraulic system 140. Once the controller 172 receives an engine RPM input at the engine RPM sensor 181, the controller 172 may make a determination of whether the RPM is at an acceptable value or within an acceptable range. If the value or range is acceptable, the controller 172 may allow operation of the hydraulic pump 144. The RPM input may be provided by a gauge signal, or from a sender, or from a CAN signal. In some embodiments and without limitation, the desired RPM may be within a range of about 350 to about 3000 RPM, and in some other embodiments and without limitation, the desired RPM range may be between about 500 and 2500 RPM.

Additionally, the controller 172 may receive an input of the vehicle speed from a vehicle speed sensor 182. Safe operation of the dump body 120 may require the speed of the dump truck 100 to be below a certain speed or within a certain speed range. In some embodiments for example, the speed of the dump truck 100 may be desirable to be below 15 miles per hour, for non-limiting example. The vehicle speed range may be programmed either by the truck builder or may also be user definable by communicating with the controller 172 with a communication device such as a smart phone, smart pad, laptop, other handheld maintenance or diagnostic device, or the like. In operation, therefore, the controller 172 may receive the vehicle speed input at the vehicle speed sensor 182 of from a speedometer gauge, from a sender, or from a CAN signal. The input therefore defines a speed monitor for the vehicle. The controller 172 may use that input information to make a determination as to whether such characteristic is within a desired range.

Additionally, the controller 172 may also receive an input related to lateral inclination. It may be unsafe to raise the dump body 120 if the truck is tilted laterally (side-to-side) outside of a certain range. For example, the truck should not be inclined more than about 16 degrees from a vertical reference. The sensor input may therefore be provided by an inclinometer. The incline sensor 183 therefore provides an angle of lateral vehicle tilt to the controller 172. The controller 172 may then make a determination as to whether the tilt value of the vehicle is within a desirable range. If the controller 172 determines that the angle of the vehicle is within a desirable range, the controller 172 may allow operation of the PTO 142 by engagement with the transmission 102. Additionally, an optional sensor may be provided which also measures front to rear incline. It may also be that the safe operation of the dump body 120 may require that the front to rear tilt (or vice-versa) be considered by the controller 172 before allowing operation of the hydraulic system 140 and engagement of the PTO 142.

It should be noted that the controller 172 may require acceptable conditions from some or all of the inputs 180. In a safest operating condition, all of the inputs 180 should be in an acceptable condition or range. However, in some instances, it may be that only one or more of the sensor inputs 180 must be within the acceptable range. Further, as described later herein, the system may comprise a bypass to override the controller 172 determination.

Controller 172 can also include one or more transmitting, receiving, or transceiving components for transmitting/receiving communications with other devices communicatively coupled with the dump truck 100. For example, and without limitation, as shown in the figure in an input/output (I/O) connector 184. The connector 184 may provide for connection of an input device with the controller 172. The I/O connector 184 may also be used to communicate with a laptop, smart phone, smart pad, or a diagnostic device. The laptop, smart phone, smart pad may be provided to diagnostic purpose and to input or change any variables, such as acceptable RPM, acceptable speed, and/or acceptable inclinometer. The I/O connector 184 may comprise any of various type of wired connectors, for example but without limitation serial I/O, parallel I/O, USB, USB-C, Thunderbolt, among others. In some embodiments, the connector 184 may be a CG150 connector. The I/O connector 184 may also comprise a wireless connection such that controller 172 can connect to and communicate over one or more wireless networks with one or more network nodes. Connections may be for example, and without limitation, Wi-Fi communication standard, Bluetooth, ZigBee, or other wireless connection. Further, the connector 184 may be embodied by both wired and wireless communication standards. Additionally, or alternatively, one or more transmitting, receiving, or transceiving components can be located on or off the board of the controller 172.

In other embodiments, the language of the inputs 180 may be J1959-CAN language, wherein the engine RPM is obtained from the CAN BUS, the PTO switch status is provided from the CAN BUS and the vehicle speed is obtained from the CAN BUS. The inclinometer 183 may be provided by a sensor. All of the inputs 180 have been described as providing input to the controller, upon which the controller may make a determination. In some embodiments, the controller 172 uses this input in summation. In other words, the controller 172 may make a series of decisions, all of which should be within a preselected parameter in order to allow operational engagement of the PTO 142 with the transmission 102.

Additionally, a strobe light 192 is shown as an output from the controller 172. With the switch 147 (FIG. 5) engaged, and assuming the controller 172 makes a determination to allow engagement of the PTO 142 with the transmission 102, the strobe light 192 will begin flashing. The flashing light serves as an alert to anyone in the area that the PTO 142 is engaged. This may stay on while the dump body 120 moves through a cycle or while the dump body 120 is raised or lowered. When the strobe light 192 is operating, the controller 172 may continuously monitor the status of the PTO output 196 so as to turn off the strobe light 192 when the PTO is disconnected by the controller 172. Additionally, a manual switch may be provided to operate the strobe light 192, separate of the controller 172, if needed or desired.

Additionally shown in the schematic view is an optional messaging box 194. The controller 172 may be connected to a messaging box 194 for the driver, user, or mechanic, which can provide information in the cab or at a location where the controller is located. The optional messaging box 194 may provide messages that inform a driver of the status of the PTO engagement or disengagement. The messaging box 194 may provide information related to preclusion of PTO engagement-for example excessive tilt measurement at the inclinometer, or excessive vehicle speed, or excessive engine RPM. The message box 194 may be positioned in any location where the user may see the messaging being provided, for example in the cab 116 of the dump truck 100.

The controller 172 is also provided with a power input 171. The power input 171 may be provided in some embodiments by an alternator or a vehicle battery, which may be an engine battery, or a house battery which is dedicated to power needs other than the engine 110.

Also shown in communication with the controller is a user bypass 185. This may be in the form of a switch or if a display is provided, in the form of a touch screen prompt. The user bypass 185 may be instances in which the determinations of the controller 172 may need to be by-passed by the driver of the dump truck 100. For example, the bypass function may be desirable when a sensor is known to be broken and precluding the proper use of the dump body.

Still further, the controller 172 further comprises an output 196 which connects electrically with the PTO 142 to direct engagement or disengagement of the PTO 142 with the transmission 102. As noted previously, the engagement of the PTO with the transmission 102 allow the pump 144 to operate and function of the hydraulic system 140.

Also shown is a body up output 197. In some embodiments, the controller 172 may also receive a body up signal 197 which tells the controller 172 when the body 120 is in an up position. If the body 120 is up, the vehicle speed or the engine RPM may be limited.

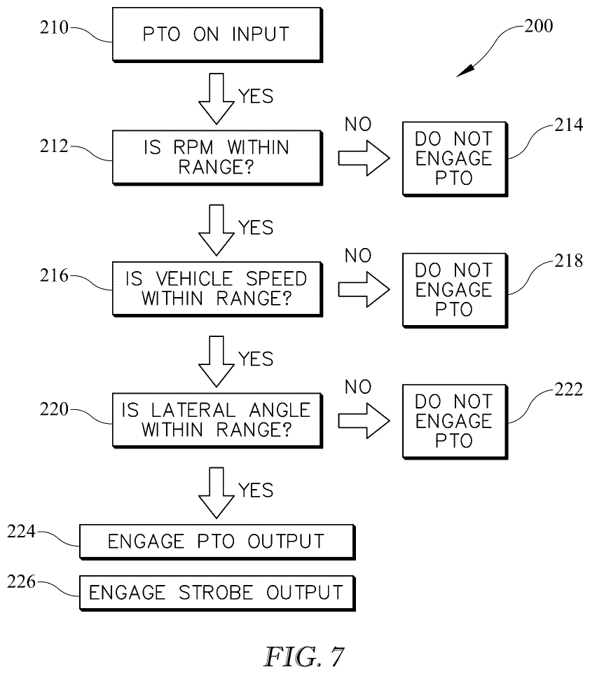

Referring now to FIG. 7, a method, or process, of operation 200 for the dump body is provided and embodied in the form of a flow chart. The method 200 is provided wherein the PTO switch 147 (FIG. 6) is actuated provide a PTO ON input at step 210. This actuation of the switch 147 begins the process.

In a next series, a plurality of steps occur. The steps may be in the order depicted or may be in other orders of operation. In some embodiments, the controller 172 determines if the engine RPM is within a specific range, at step 212. As discussed, it is desirable that the engine operate within a specific RPM range to preclude damage to the hydraulic pump. If the controller 172 determines that the RPM is not within range, the PTO will not engage at step 214. Alternately, if the engine RPM is determined to be within range, then the method moves to the next step.

In some embodiments, the controller 172 next determines if the vehicle speed is within a desired range, at step 216. As noted, the dump truck should be stopped to operate the dump body, or in the alternative only operating at a limited speed. If the controller 172 determines that the truck is not operating at or within a desired speed or speed range, the PTO will not engage at step 218. The determinations of steps 212 and 216 may be made by inputs from the CAN bus of the dump truck, in some embodiments.

In some embodiments, the controller 172 also checks the angle of the dump truck. This may be a lateral angle, as depicted, a forward-rearward angle, or both, for example. This may occur at step 220. The controller 172 may receive an input from one or more inclinometers 183 and make the determination of whether the angle input is within an acceptable value or range. If the controller 172 determines the angle is not acceptable, the PTO will not engage at step 222. If the controller 172 determines that the angle is within a desired range, the PTO output signal 196 is provided and the PTO is engaged to operate the hydraulic pump, at step 224. Further, if the controller 172 determines that the PTO is to be engaged, the controller may also start the strobe light 192 operation, at step 226. In some embodiments, the controller 172 may continuously or periodically run through the method 200 to make sure the dump body is being operated only in satisfactory conditions.

As noted previously, while the steps of the method 200 are shown in one order, the order of the steps may be altered for the order shown. For example, the angle determination may be made first and the CAN bus inputs may be acquired for engine RPM and vehicle speed afterward. Also, the order of the engine RPM and vehicle speed may be changed. Additionally, more or less steps may occur than shown. This is merely illustrative.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B or C as well as any combination thereof.

The foregoing description of methods and embodiments has been presented for purposes of illustration. It is not intended to be exhaustive or to limit the teaching to the precise steps and/or forms disclosed, and obviously many modifications and variations are possible in light of the above teaching. It is intended that the scope of the teaching and all equivalents be defined by the claims appended hereto.

1. A dump truck, comprising:
a truck main body having a frame, a plurality of wheel assemblies;
an engine and a transmission which operably drive at least some of the plurality of wheel assemblies;
a dump body having a base, a plurality of walls extending from the base, and defining a cavity wherein contents may be positioned in the dump body, at least one movable gate which moves between a closed position and an opened position to discard said contents from the cavity;
a hydraulic system which is driven by a power take off (PTO) operably connected to the transmission and which powers movement of the dump body from a first position in which said contents may be stored, to a second upstanding position in which the contents may be discarded;
a controller for said hydraulic system having a plurality of features, said features comprising:
an RPM monitor for the engine, which allows operation of the PTO and the hydraulic system only if the engine is in within a preselected RPM range;
a lateral angle inclinometer which determines if the truck main body is within a preselected range of lateral incline to allow operation of the PTO and the hydraulic system;
a speed monitor which determines if the dump truck is below a preselected speed for safe operation of the PTO for operation of the dump body;
a strobe light in electrical communication with said controller, said strobe light being operated by said controller when said PTO is engaged.

2. The dump truck of claim 1, said controller further comprising an override option which allows a user to bypass one or more of said features of the controller.

3. The dump truck of claim 1, said controller further comprising a text box for messaging a user.

4. The dump truck of claim 1, wherein said RPM monitor precludes engagement of the PTO if an engine RPM is outside of the preselected RPM range.

5. The dump truck of claim 4, said preselected RPM range being between about 350 RPM and 3000 RPM.

6. The dump truck of claim 1, further comprising a second inclinometer for measuring front to rear tilt of the dump truck.

7. The dump truck of claim 1, said lateral angle inclinometer having said preselected range of lateral incline being between about 0 and about 16 degrees to allow operation.

8. The dump truck of claim 1, further comprising a user defined input for the speed monitor.

9. The dump truck of claim 8, wherein said preselected speed is between about 0 mph and 16 mph.

10. A method of operating a dump body, comprising the steps of:
receiving an input at a controller to operate the dump body;
determining, by a first input and with said controller whether an engine RPM is within a first acceptable range;
determining, by a second input and with said controller whether a vehicle speed is within a second acceptable range;
determining, by a third input and with said controller whether an angle of said vehicle speed is within a third acceptable range.

11. The method of claim 10, further comprising providing an override option which allows a user to bypass one or more of the first acceptable range, the second acceptable range, or the third acceptable range.

12. The method of claim 10, further comprising providing a power take off (PTO) output by said controller to engage said PTO.

13. The method of claim 11, further comprising providing a strobe light output signal by said controller to operate a strobe light.

14. The method of claim 11, further comprising moving the dump body if said first acceptable range, said second acceptable range, and said third acceptable range are met.

15. The method of claim 10, wherein said angle is front-to-rear angle, lateral angle, or both.
